(19) United States
(12) Patent Application Publication
(10) Pub. No.: US 2002/0198908 A1
(43) Pub. Date: Dec. 26, 2002

(54) Method and apparatus for delivery of external data from a centralized repository in a network data processing system

(75) Inventor: John Mark Hartel, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/886,162

(22) Filed: Jun. 21, 2001

(51) Int. Cl. G06F 15/00

(52) U.S. Cl. 707/513

(57) ABSTRACT

A method, apparatus, and computer implemented instructions for processing data. A markup language data file describing an object is read. The data in the file is translated into a database representation. The database representation is stored in a database. In response to receiving a request from a requestor, the database is queried. In response to receiving a result, the result is translated into the object, and the object is sent to the requestor.

### BACKGROUND OF THE INVENTION

1. Technical Field

The present invention provides an improved data processing system and in particular a method and apparatus for delivering data. Still more particularly, the present invention provides a method and apparatus for delivering data in a network of data processing systems.

2. Description of Related Art

Network data processing systems have enabled the distribution of data. For example, software systems often make use of customizable external data to ensure generality and flexibility. External data is data that describes a system or model. For example, external data may be data describing a graphical user interface (GUI) system. This form of external data may range from simple configuration settings to complex process control descriptions. Delivering this external data to the appropriate location at the appropriate time during processing when this data is needed may be problematic. This is especially true across distributed systems. Severe data synchronization and duplication issues often arise.

Customers desire to have a suite of applications that have the same look-and-feel. For example, with graphical user interfaces, mismatched look-and-feel often occurs between different applications or even within an application because different application teams will work on different portions of a suite of applications. Further, with different teams working on a program, duplication of code also may occur.

Therefore, it would be advantageous to have improved method, apparatus, and computer implemented instructions for delivering data for use in applications such as creating graphical user interfaces.

### SUMMARY OF THE INVENTION

The present invention provides a method, apparatus, and computer implemented instructions for processing data. A markup language data file describing an object is read. The data in the file is translated into a database representation. The database representation is stored in a database. In response to receiving a request from a requestor, the database is queried. In response to receiving a result, the result is translated into the object, and the object is sent to the requestor.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram of object relationships for a graphical user interface system in which class hierarchies are present in accordance with the preferred embodiment of the present invention;

FIG. 5 is a diagram illustrating a system for storing and delivering external data in accordance with a preferred embodiment of the present invention;

FIG. 6 is a diagram illustrating an XML definition for an action object in accordance with the preferred embodiment of the present invention;

FIG. 7 is a diagram illustrating entry in a centralized repository in accordance with a preferred embodiment of the present invention;

FIG. 8 depicts a flowchart of a process used for importing a definition into a centralized repository in accordance with a preferred embodiment of the present invention;

FIG. 9 is a flowchart of a process used for processing a query request from a proxy in accordance with a preferred embodiment of the present invention;

FIG. 10 is a flowchart of a process used for sending a query request to a data server in accordance with a preferred embodiment of the present invention;

FIG. 11 depicts a flowchart of a process used for placing definitions of objects in a centralized repository in accordance with a preferred embodiment of the present invention;

FIG. 12 is a flowchart of a process used for removing a package from a central repository in accordance with a preferred embodiment of the present invention; and

FIG. 13 is a flowchart of a process used for subscribing to database change events in accordance with a preferred embodiment of the present invention.

### DETAILED DESCRIPTION OF THE PREFERRED EMBODIMENT

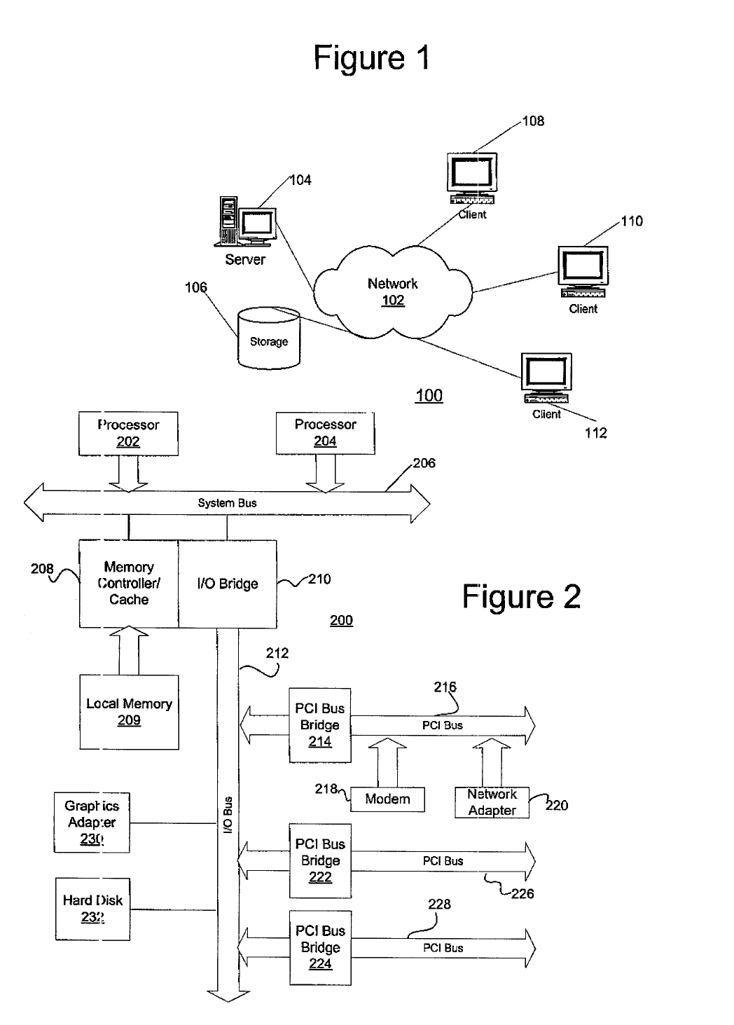

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be implemented to execute the processes used to manage a centralized repository. The centralized repository in these examples takes the form of a database and may be located within data processing system 200 or on another storage device, such as, for example, storage unit 106 in FIG. 1.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses, 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

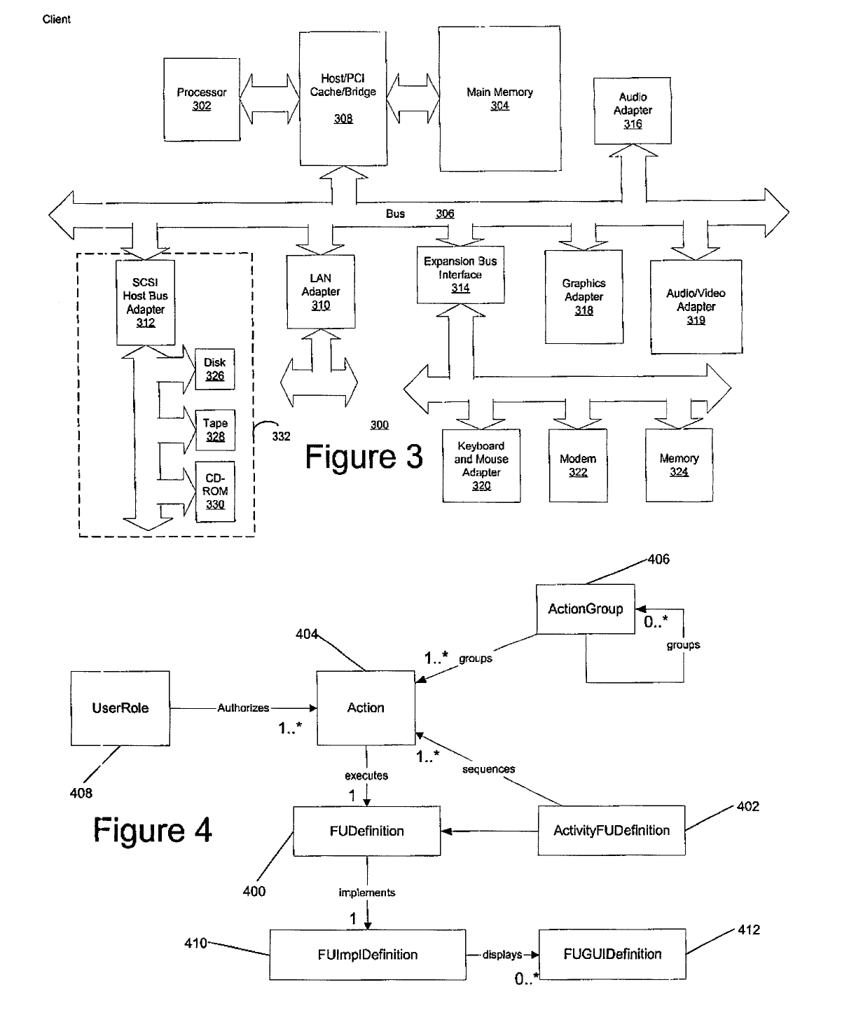

With reference now to FIG. 3, a block diagram illustrating a data processing system is depicted in which the present invention may be implemented. Data processing system 300 is an example of a client computer. Data processing system 300 is an example of a data processing system in which requests may be made for information from the centralized repository. A data proxy, which will be described in further detail below, may provide the interface between the centralized repository and the local processing environment on data processing system 300.

Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object-oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand-held computer in addition to taking the form of a PDA. Data processing system 300 also may be a kiosk or a Web appliance.

Turning now to FIG. 4, a diagram of object relationships for a graphical user interface system in which class hierarchies are present is depicted in accordance with the preferred embodiment of the present invention. In particular, this diagram illustrates object relationships for different components used in a graphical user interface (GUI) console. The mechanism the present invention allows for different application to use a common GUI console. The mechanism of the present invention imports XML definitions of these different objects that form the graphical user interface hierarchy. The XML definitions are persisted to a relational database and these definitions are center served to various console or clients on demand. Additionally, the mechanism provides an ability to notify the clients or consoles of any definition changes. These objects are also referred to as management components. These management components define an execution sequence to a JAVA graphical user interface console.

In FIG. 4, these management component objects include functional unit 400, activity functional unit 402, action 404, action group 406, user role 408, functional unit implementation 410, and functional unit GUI 412. Functional unit 400 represents an executable unit of work and identifies a functional unit implementation, such as functional unit implementation 410. For example, the functional unit implementation may be to display an icon or initiate execution of an action, such as a copy function. Further, functional unit 400 also identifies input/output parameters. Activity functional unit 402 represents a sequence set of work units making up an activity and identifies actions that form the sequence. These functional units may be of any size depending on the number of actions making up the sequence for a unit. Action 404 represents a functional unit to the user and identifies a functional unit to execute. Further, action 404 is presented to a user via a GUI console. Action group 406 represents a group of actions to the user. Action group 406 logically groups sets of actions and also can group itself to allow for a nested tree structure. This component is presented to a user via the GUI console.

Next, user role 408 represents the role of a user and identifies actions that a user with that role is authorized to execute. Functional unit implementation 410 represents the implementation of a functional unit. This component identifies a JAVA bean in these examples containing implementation code. Further, this component identifies multiple view GUIs associated with this implementation's model. Functional unit GUI 412 is a component representing the view portion of the functional unit implementation. In a preferred embodiment, this component identifies a JAVA bean containing GUI implementation code. All of these components make up the management component system for representing various GUIs to user. The graphical user interface consoles are located in a local processing environment. In these examples, the consoles are Java GUI consoles with the components being made up of components written in Java.

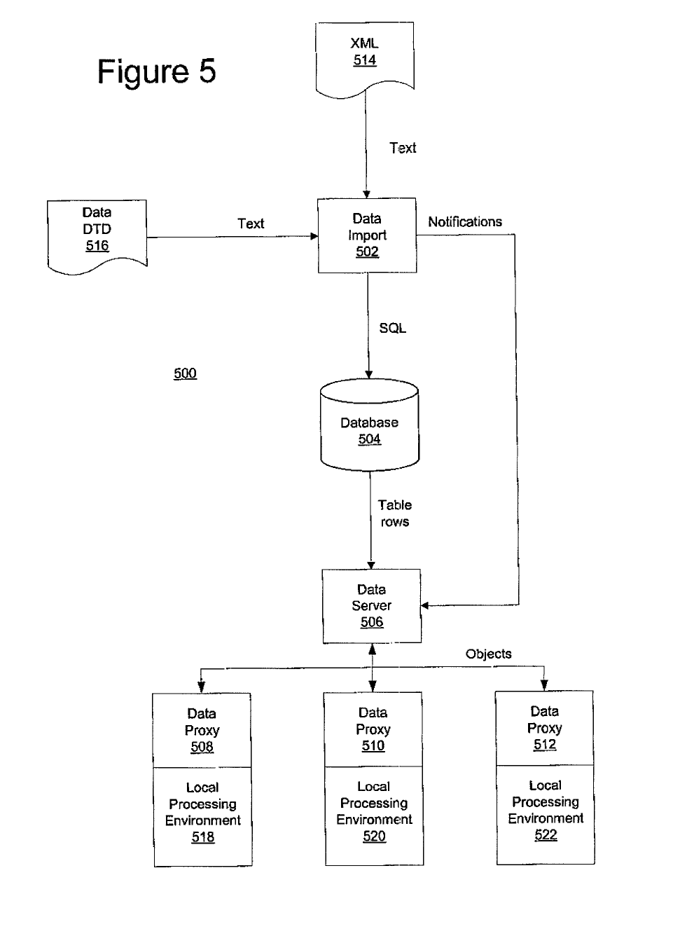

Turning next to FIG. 5, a diagram illustrating a system for storing and delivering external data is depicted in accordance with a preferred embodiment of the present invention. The centralized repository system in this example includes data import 502, database 504, data server 506, and data proxies 508-512. Data import 502 functions to receive data, such as data found in extensible markup language (XML) file 514. This data file describes a data structure, such as a Java class, in instance of a Java object, or some other object. Data import 502 validates the data in XML file 514 using document type definition (DTD) data. 516. DTD is a language that describes a markup language document and is used with XML.

After the data in XML file 514 is validated, this data is translated to a database representation by data import 502. Thereafter, the data is persisted or stored in database 504. Additionally, data import 502 will send notifications to data proxies 508-512 through data server 506 to indicate that new data has been added to database 504.

Data server 506 functions to accept requests from data proxies, such as data proxies 508-512. In response to receiving a query, data server 506 will query database 504 and retrieve or fetch data from database 504. This data is translated into an object representation by data server 506 and delivered to the proxy that originated the request. In these examples, the object representation is in the form of a Java object.

Data proxies 508-512 are located in data processing systems, such as data processing system 300 in FIG. 3. Data proxies 508-512 receive requests from applications such as those on local processing environments 518-522. Graphical user interface consoles, such as the one described with respect to FIG. 4 above, may be located in local processing environments 518-522. These requests are sent to data server 506. Results are received from data server 506. These results often take the form of a data object, such as code. In response, data proxies 508-512 send these results to local processing environments 518-522, respectively. Scaling of these data proxies servers may be made to provide more processing points. In addition, an additional data server, such as data server 506, may be added to increase processing resources. In this case, the additional data server would point to database 504 and requests are sent from data proxies to these data servers using various load balancing mechanisms. This system provides localization on a central server. Further, data of any complexity may be placed in database 504 for use. Data is pulled from the repository in database 504 only when needed. Also, data caching may be implemented in data server 506 or on data proxies 518-522 to improve performance. In these examples, data also may be tagged with additional information, such as version information, access permissions, and revision dates. These proxies appear as a black box to the local processing environment. As a result, any object transmission mechanism may be used between a proxy and a data server. In this manner, applications in the local processing environment are not required to be modified to access information from data server 506.

Thus, a designer for a system, such as a graphical user interface (GUI) system, may define external data for the system in XML without having to have knowledge of the environment in which the GUI system will be implemented. The mechanism of the present invention employs data import 502 to convert the external data from an XML format to a table based format, which is stored in database 504. In this manner, a request for a particular action or function in the GUI system may be made from a Java programming environment in local processing environment 518. In this instance, the object returned by data server 506 is a Java object for the action or function. If a request is received from a different programming environment, such as a C programming environment in local processing environment 520, data server 506 will return C code for the action or function. In these example, the requests for action or function include an identification of the local processing environment.

Although the depicted examples illustrate data as being described in a XML file, other markup languages or other languages may be used to describe the data for import by data import 502 depending on the particular implementation. For example, the mechanism of the present invention may be applied to an HTML file. End points, such as applications in local processing environment, may request information and components using different mechanisms depending on the particular implementation. For example, in a graphical user interface (GUI) system a tree structure may be returned to a data proxy, such as data proxy 510, in response to a request from a application or program in local processing environment 520. This tree structure contains a list of actions for various elements. This tree structure may be displayed on a screen for use by a user. The tree structure contains universal resource locators (URLs) to objects that implement these actions. By selecting one of these elements, the object containing the function for the action may be retrieved by using the URL.

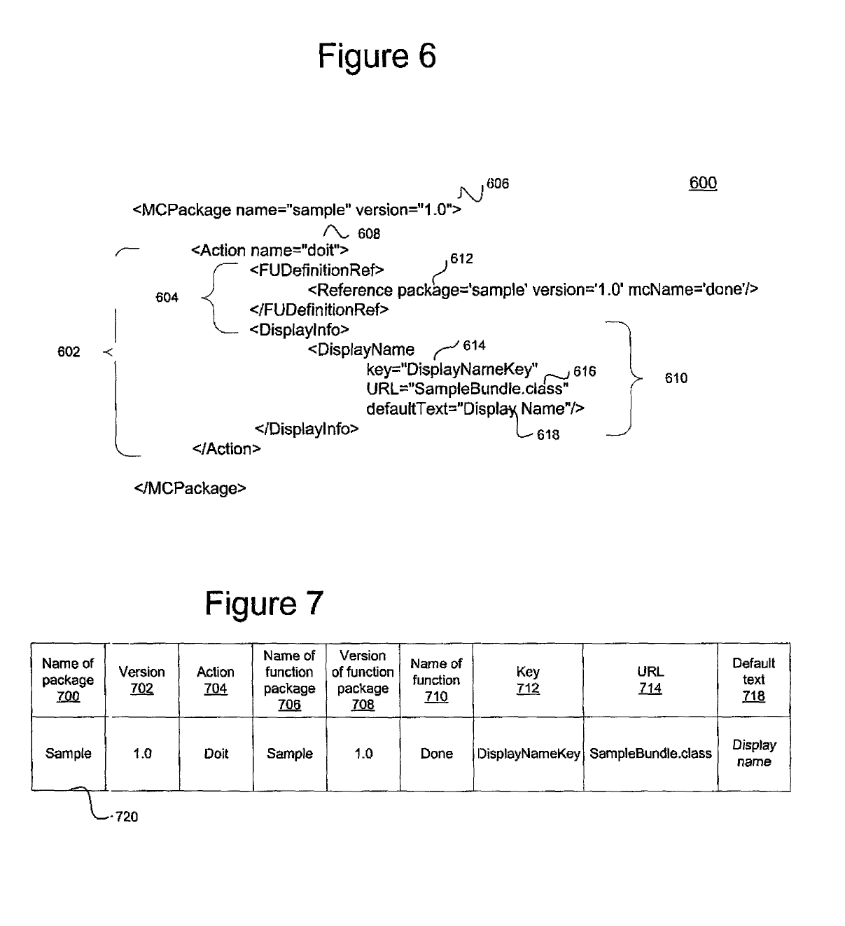

Turning next to FIG. 6, a diagram illustrating an XML definition for an action object is depicted in accordance with the preferred embodiment of the present invention. XML definition 600 of an extensible markup language file such as extensible markup language file 414 in FIG. 4. XML definition 600 may be processed by data import 402 to generate entries for placement within database 404 in these examples. Section 602 is an XML description of an instance of an action object, such as action 404 in FIG. 4. Section 604 is an XML description of an associated reference to an instance of a functional unit definition object, such as functional unit 400 in FIG. 4. In line 606, the package name is “sample” with the version being 1.0. In this example, the action definition object has a name of “doit” in line 608. The name of the functional unit, in this example, is “done” as shown in line 612.

Basically, section 604 provides the reference from action 404 to functional units definition 400 in FIG. 4. This hierarchy of object relationships is an example of a group of object classes in instances with different hierarchies that may be processed using the mechanism of the present invention for distribution to various consoles or terminals in different data processing systems.

Section 610 illustrates field level information of action object and determines the user readable name. In line 614, the key is “DisplayNameKey”. The URL is “SampleBundleClass” as shown in line 616. The default text is “Display Name” in line 618. In these examples, the key, the URL, and the default text are information used to provide an ability to have the presentation of the actions in a form that is translatable into different languages.

Turning next to FIG. 7, a diagram illustrating an entry in a centralized repository is depicted in accordance with a preferred embodiment of the present invention. FIG. 7 illustrates an example of an entry within a centralized repository, such as database 504 in FIG. 5. In this example, each entry includes name of package 700, version 702, action 704, name of function package 706, version of function package 708, name of function 710, key 712, URL 714, and default text 718. This information corresponds to information obtained from an XML document or data structure. For example, entry 720 includes information corresponding to XML definition 600 in FIG. 6.

Other information may be included in addition to or in place of those illustrated in entry 720. For example, a host identification, owner name, and a server port may be additional information included in entry 720. Depending on the component type of an object, an entry may include one or more references to other entries in a different table. These entries may contain information specific to different methods for the object.

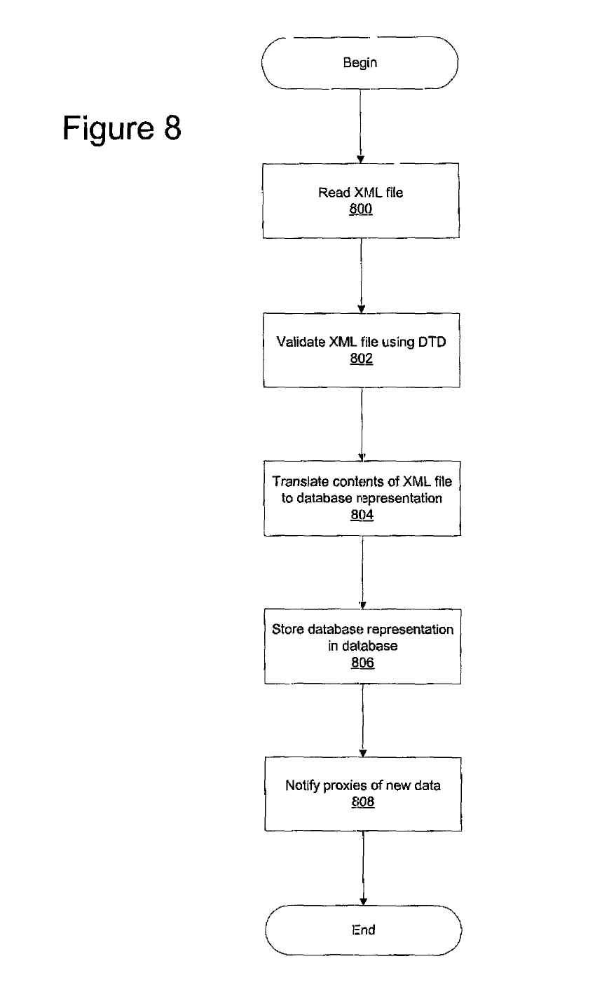

Turning next to FIG. 8, a flowchart of a process used for importing a definition into a centralized repository is depicted in accordance with a preferred embodiment of the present invention. A definition is a description of a data item or object, including the actions or functions performed by the object in response to selected inputs. The process illustrated in FIG. 8 may be implemented in a data import, such as data import 502 in FIG. 5.

The process begins by reading the XML file (step 800). Next, the XML file is validated using DTD data (step 802). The contents of the XML file are translated to a database representation (step 804). The process includes a mapping mechanism used to identify fields within the XML file and convert that information into a form appropriate for storage within a table in the database to form the database representation. The XML file represents a object, such as a Java class, an instance of a Java object, or an piece of C code. The translation is performed by parsing the XML file for selected fields and translating the information in those fields into information for storage and database table rows. Error checking may be used while importing data to ensure that no duplication between components occurs. Then, the database representation is stored in the database (step 806). Proxies are notified of new data (step 808) with the process terminating thereafter.

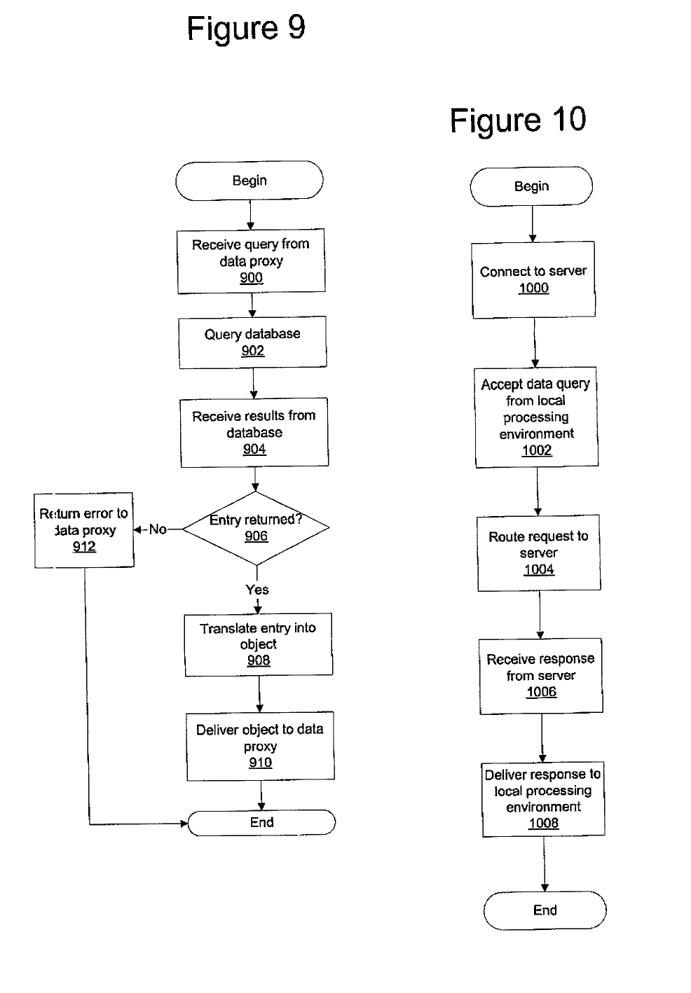

Turning next to FIG. 9, a flowchart of a process used for processing a query requests from a proxy is depicted in accordance with a preferred embodiment of the present invention. The process illustrated in FIG. 9 may be implemented in a data server, such as data server 506 in FIG. 5.

The process begins by receiving a query from a data proxy (step 900). Next, the database is queried (step 902). Results are received from the database (step 904). A determination is then made as to whether an entry is returned (step 906). If an entry is returned, the entry is translated into an object (step 908). In step 908, the data server retrieves the entry corresponding to the request and translates the entry into an object using a mapping mechanism. The mapping mechanism is predefined to convert fields within an entry into the appropriate format to form the object. This object may be, for example, a Java class, an instance of a Java object, or a piece of C code. In these examples, the translation is performed by fetching database table rows, which contain the object information. From these rows, an appropriate Java object is constructed and the fields within this Java object are populated using information from one or more table rows. Then, the object is delivered to the data proxy (step 910) with the process terminating thereafter. The object may be delivered to the data proxy in a number of different ways. For example, a universal resource identifier, such a universal resource locator, may be sent to the data proxy. Alternatively, the object itself may be sent to the data proxy.

With reference again to step 906, if an entry is not returned, an error is returned to the data proxy (step 912). In this example, a not found exception is returned if an entry corresponding to the request is absent.

Turning next to FIG. 10, a flowchart of a process used for sending a query request to a data server is depicted in accordance with a preferred embodiment of the present invention. The process illustrated in FIG. 10 may be implemented in a data proxy, such as data proxy 508 in FIG. 5.

The process begins by establishing a connection to a server (step 1000). Next, a data query is accepted from a local processing environment (step 1002). A request is routed to the server (step 1004). A response is then received from the server (step 1006). The response may take the form of the data object or a universal resource identifier pointing to the data object. If the result is a universal resource identifier, then the proxy may obtain the object from the location identified by the universal resource identifier prior to delivering the response to the local processing environment. Then, the response is delivered to the local processing environment (step 1008) with the process terminating thereafter.

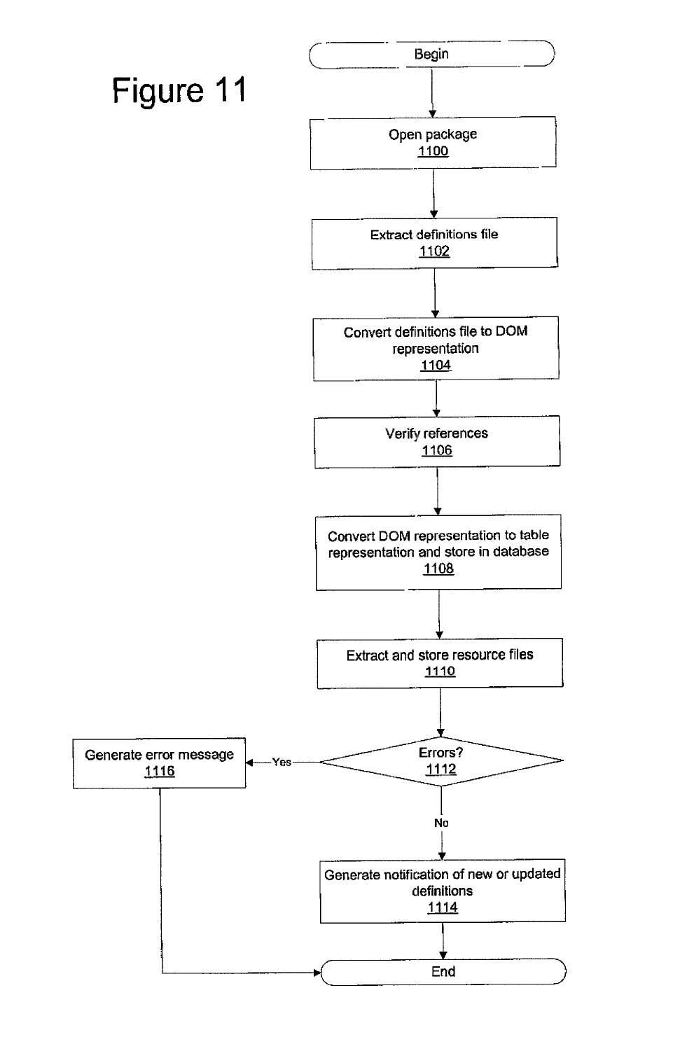

Turning next to FIG. 11, a flowchart of a process used for placing definitions of objects in a centralized repository is depicted in accordance with a preferred embodiment of the present invention. The process illustrated in FIG. 11 may be implemented in data import 502 in FIG. 5 and is an example of one embodiment for processing a data file for placement in a centralized repository, such as database 504 in FIG. 5.

The process begins by opening a package (step 1100). In this example, the package is a Java archive (JAR) file containing classes as well as other information. Next, a definitions file is extracted from the package (step 1102). The definitions file is converted to document object model (DOM) representation (step 1104). DOM provides an object representation of an XML document. Then, the references are verified (step 1106). The DOM representation is converted to a table representation and stored in a database (step 1108).

The resource files are then extracted from the package and stored (step 1110). A determination is made as to whether errors occur (step 1112). These resource files may be stored locally on the same data processing system as database 504 in FIG. 5 or on a remote storage device depending on the particular implementation. A notification of new or updated definitions is generated (step 1114) with the process terminating thereafter.

With reference again to step 1112, if errors occur, an error message is generated (step 1116) with the process terminating thereafter.

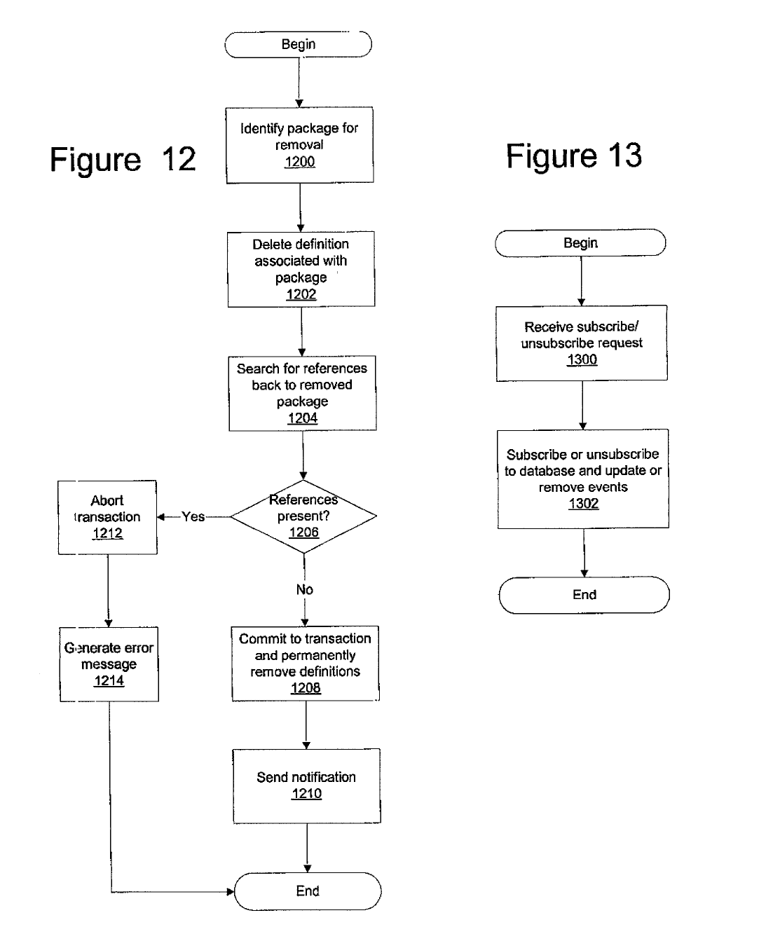

Turning next to FIG. 12, a flowchart of a process used for removing a package from a central repository is depicted in accordance with a preferred embodiment of the present invention.

The process begins by identifying a package for removal (step 1200). Next, the definition associated with the package is deleted (step 1202). References back to the removed package are searched for (step 1204). A determination is made as to whether references are present (step 1206). If no references are present, the transaction is committed to and the definitions are permanently removed (step 1208). Then a notification is sent (step 1210) with the process terminating thereafter.

With reference again to step 1206, if references are present, the transaction is aborted (step 1212). Next, an error message is generated (step 1214) with the process terminating thereafter.

Turning next to FIG. 13, a flowchart of a process used for subscribing to database change events is depicted in accordance with a preferred embodiment of the present invention. The process illustrated in FIG. 13 may be implemented on a data server, such as data server 506 in FIG. 5 to process requests for data objects, such as a JAR.

The process begins by receiving a subscribe/unsubscribe request (step 1300). Next, a database is subscribed to or unsubscribed to and events are updated or removed (step 1302) with the process terminating thereafter. Event subscription is performed by the application notifying a data proxy of the type of data objects on which the application wishes to add, remove, or modify events. This notification or request is passed from the data proxy to the data server. When the data server is notified by a data importer of new XML information being imported, the data server will publish the information to the appropriate subscribers. In the depicted examples, the Java Messaging Service (JMS) is used as a publish/subscribe mechanism.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal-bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links and wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted examples illustrate the use of JAR files and Java objects, the mechanism of the present invention may be applied to other types of data objects. Further, although the file describing the data object takes the form of a markup language file, other types of descriptions may be used depending on the particular implementation. The embodiment was chosen and described in order to best explain the principles and the practical application of the invention, and to enable others of ordinary skill in the art to understand the invention for various embodiments with various modifications as are suited to the particular use contemplated.

What is claimed is:

1. A method in a data processing system for transferring data, the method comprising:
receiving data describing objects;
storing the data in a database format in a database;
responsive to receiving a request for an object from a processing environment, retrieving data corresponding to the object from the database; and
translating the data corresponding to the object into a form for use by the processing environment.

2. The method of claim 1, wherein the data is in a markup language data file.

3. The method of claim 1, wherein the database format is a set of entries in a table.

4. The method of claim 1, wherein the request originates from a data proxy.

5. The method of claim 1, wherein the processing environment is a Java processing environment and the form is a Java class.

6. A method in a data processing system for transferring data, the method comprising:
receiving a markup language file describing at least one object;
converting the markup language file to at least one table in a database, wherein the at least one table contains object parameters for the at least one object;
responsive to a request for an object from a requestor, translating the at least one table into the object; and
sending the object to the requestor.

7. The method of claim 6, further comprising:
validating the markup language file using a document type definition file prior to the prior to converting the markup language file.

8. The method of claim 6, wherein the request for the object is for an object in a desired form selected among a plurality of available object forms and wherein the tranlating step translates the table into the desired object form.

9. The method of claim 6, wherein the object is a graphical user interface object used for representing a system resource in a graphical user interface.

10. A method in a data processing system for transferring data, the method comprising:
storing external customizable data for use by a software system during execution of processes by the software system in a central repository, wherein the software system is distributed within a network data processing system; and
delivering the external customizable data in a format usable by the software system in response to requests from the software system.

11. The method of claim 10, wherein the external customizable data is an extensible markup language data file.

12. The method of claim 10, wherein the object is an instance of a Java class.

13. The method of claim 10, wherein the requestor is a data proxy.

14. The method of claim 10, wherein the object is a Java class.

15. The method of claim 10, wherein the object is an instance of a Java object.

16. The method of claim 10, wherein the step of sending the object to the requestor comprises:
sending a universal resource identifier to the requestor.

17. The method of claim 10, wherein the external customizable data is a markup language file and further comprising:
validating the markup language file.

18. The method of claim 17, wherein the markup language file is an extensible markup language file.

19. The method of claim 18, wherein the extensible markup language file is validated using a document type definition file.

20. A system for transferring data, the system comprising:
a database, wherein the database contains representations of objects;
a data import process, wherein the data import process receives an external data file describing an object, translates external data file into a representation, and stores the representation in the database; and
a data server process, wherein the data server process receives a request from a requestor, fetches a selected representation in response to receiving the request, translates the selected representation into an object, and sends the object to the requestor.

21. The system of claim 20 further comprising:
a set of data proxies, wherein a data proxy within the set of data proxies connects to the data server process, receives a request from a local processing environment, routes the request to the data server, receives a result from the data server process, and sends the result to the local processing environment.

22. The system of claim 20, wherein the external data file is a markup language file.

23. The system of claim 20, wherein the markup language file is an extensible markup language file.

24. A data processing system comprising:
a bus system;
a communications unit connected to the bus, wherein data is sent and received using the communications unit;
a memory connected to the bus system, wherein a set of instructions is located in the memory; and
a processor unit connected to the bus system, wherein the processor unit executes the set of instructions to receive data describing objects; store the data in a database format in a database; retrieve data corresponding to the object from the database in response to receiving a request for an object from a processing environment; and translate the data corresponding to the object into a form for use by the processing environment.

25. The data processing system of claim 24, wherein the bus system includes a primary bus and a secondary bus.

26. The data processing system of claim 24, wherein the processor unit includes a single processor.

27. The data processing system of claim 24, wherein the processor unit includes a plurality of processors.

28. The data processing system claim 24, wherein the communications unit is an Ethernet adapter.

29. A data processing system comprising:
a bus system;
a communications unit connected to the bus, wherein data is sent and received using the communications unit;
a memory connected to the bus system, wherein a set of instructions is located in the memory; and
a processor unit connected to the bus system, wherein the processor unit executes the set of instructions to receive a markup language file describing at least one object; convert the markup language file to at least one table in a database, wherein the at least one table contains object parameters for the at least one object; translating the at least one table into the object in response to a request for an object from a requestor; and send the object to the requester.

30. The data processing system of claim 29, wherein the bus system includes a primary bus and a secondary bus.

31. The data processing system of claim 29, wherein the processor unit includes a single processor.

32. The data processing system of claim 29, wherein the processor unit includes a plurality of processors.

33. The data processing system claim 29, wherein the communications unit is an Ethernet adapter.

34. A data processing system comprising:
a bus system;
a communications unit connected to the bus, wherein data is sent and received using the communications unit;
a memory connected to the bus system, wherein a set of instructions is located in the memory; and
a processor unit connected to the bus system, wherein the processor unit executes the set of instructions to store external customizable data for use by a software system during execution of processes by the software system in a central repository, wherein the software system is distributed within a network data processing system; and deliver the external customizable data in a format usable by the software system in response to requests from the software system.

35. The data processing system of claim 34, wherein the bus system includes a primary bus and a secondary bus.

36. The data processing system of claim 34, wherein the processor unit includes a single processor.

37. The data processing system of claim 34, wherein the processor unit includes a plurality of processors.

38. The data processing system claim 34, wherein the communications unit is an Ethernet adapter.

39. A data processing system for transferring data, the data processing system comprising:
receiving means for receiving data describing objects;
storing means for storing the data in a database format in a database;
retrieving means, responsive to receiving a request for an object from a processing environment, for retrieving data corresponding to the object from the database; and
translating means for translating the data corresponding to the object into a form for use by the processing environment.

40. The data processing system of claim 39, wherein the data is in a markup language data file.

41. The data processing system of claim 39, wherein the database format is a set of entries in a table.

42. The data processing system of claim 39, wherein the request originates from a data proxy.

43. The data processing system of claim 39, wherein the processing environment is a Java processing environment and the form is a Java class.

44. A data processing system for transferring data, the data processing system comprising:
receiving means for receiving a markup language file describing at least one object;
converting means for converting the markup language file to at least one table in a database, wherein the at least one table contains object parameters for the at least one object;
translating means, responsive to a request for an object from a requestor, for translating the at least one table into the object; and
sending means for sending the object to the requestor.

45. The data processing system of claim 44, further comprising:
validating means for validating the markup language file using a document type definition file prior to the prior to converting the markup language file.

46. The data processing system of claim 44, wherein the request for the object is for an object in a desired form selected among a plurality of available object forms and wherein the tranlating step translates the table into the desired object form.

47. The data processing system of claim 44, wherein the object is a graphical user interface object used for representing a system resource in a graphical user interface.

48. A data processing system for transferring data, the data processing system comprising:
storing means for storing external customizable data for use by a software system during execution of processes by the software system in a central repository, wherein the software system is distributed within a network data processing system; and
delivering means for delivering the external customizable data in a format usable by the software system in response to requests from the software system.

49. The data processing system of claim 48, wherein the external customizable data is an extensible markup language data file.

50. The data processing system of claim 48, wherein the object is an instance of a Java class.

51. The data processing system of claim 48, wherein the requestor is a data proxy.

52. The data processing system of claim 48, wherein the object is a Java class.

53. The data processing system of claim 48, wherein the sending means comprises:
means for sending a universal resource identifier to the requestor.

54. The data processing system of claim 48, wherein the external customizable data is a markup language file and further comprising:
validating means for validating the markup language file.

55. The data processing system of claim 54, wherein the markup language file is an extensible markup language file.

56. The data processing system of claim 55, wherein the extensible markup language file is validated using a document type definition file.

57. A computer program product in a computer readable medium for transferring data, the method comprising:
first instructions for receiving data describing objects;
second instructions for storing the data in a database format in a database;
third instructions, responsive to receiving a request for an object from a processing environment, for retrieving data corresponding to the object from the database; and
fourth instructions for translating the data corresponding to the object into a form for use by the processing environment.

58. A computer program product in a computer readable medium for transferring data, the computer program product comprising:
first instructions for receiving a markup language file describing at least one object;
second instructions for converting the markup language file to at least one table in a database, wherein the at least one table contains object parameters for the at least one object;
third instructions, responsive to a request for an object from a requestor, for translating the at least one table into the object; and
fourth instructions for sending the object to the requestor.

59. A computer program product in a computer readable medium for use in transferring data, the computer program product comprising:
first instructions for storing external customizable data for use by a software system during execution of processes by the software system in a central repository, wherein the software system is distributed within a network data processing system; and
second instructions for delivering the external customizable data in a format usable by the software system in response to requests from the software system.
